(19) United States
(12) Patent Application Publication
(10) Pub. No.: US 2011/0095249 A1
(43) Pub. Date: Apr. 28, 2011

(54) HYDRAULIC CRANE SYSTEM FOR LIFTING A CRANE ON A VEHICLE

(76) Inventor: John Collins, Garner, IA (US)

(21) Appl. No.: 12/607,394

(22) Filed: Oct. 28, 2009

(51) Int. Cl. B66F 3/24

(52) U.S. Cl. 254/93 VA

(57) ABSTRACT

A hydraulic crane system for lifting a crane on a vehicle. The system includes a hydraulic motor that is drivingly connected to a hydraulic pump and fluidly connected to a hydraulic line of a vehicle. A crane lifting device is hydraulically actuated by the fluid supplied by the hydraulic pump wherein a remote electronic controller can be utilized to provide a signal in order to depressurize the crane lifting device using an electrically actuated valve.

### BACKGROUND OF THE INVENTION

This invention relates to vehicles that utilize cranes. More specifically, this invention relates to a hydraulic system for operating hydraulic tools such as jacks and rams.

In order to lift large industrial equipment, typically an air over hydraulic pump is used to provide hydraulic oil to the hydraulic jack to raise the equipment for compressor mounted on the service vehicle. The crane itself has a tire manipulator with rotating pads that are used to maneuver the tires. The crane and pads are controlled using a hydraulic system that is associated with the vehicle.

These service vehicles are equipped with an air compressor system that operates the air over hydraulic foot pumps that power the jacks and rams. Specifically, oftentimes in cold weather the air operated devices freeze, preventing functioning of the lifting device. In addition, the lines in these systems can become dirty, thus facilitating the freezing of lines and preventing operation. In addition, each different type of vehicle requires different flow requirements, depending on the lifting required wherein an individual in the field must regulate these flow requirements. One must also operate these foot pumps at the tire location, thus putting an individual operating the foot pumps in danger since they are next to the machine during operation. Finally, foot pumps provide a ratcheting motion that can lead to unsafe movements and compromise safety.

Thus, a principal object of the present invention is to provide a lifting system for a crane that facilitates lifting of the equipment.

Yet another object of the present invention is to provide a hydraulic crane system that improves the safety associated with use of the system.

These and other objects, features, or advantages of the present invention will become apparent from the specification and claims.

### BRIEF SUMMARY OF THE INVENTION

A hydraulic system for lifting a machine. The system includes a hydraulic motor that is drivingly connected to a hydraulic pump and fluidly connected to a hydraulic line of the vehicle. A lifting device is presented that is hydraulically actuated by fluid supplied by the hydraulic pump. An electrically actuated valve is fluidly connected between the lifting device and hydraulic line of the vehicle. An electronic controller is electrically connected to the hydraulic pump to cause hydraulic fluid to flow to the pump to lift the lifting device. The electronic controller is also electrically connected to the electrically actuated valve where the valve allows hydraulic fluid to flow from the lifting device back to the hydraulic line of the vehicle to allow the lifting device to be lowered.

### BRIEF DESCRIPTION OF THE DRAWINGS

FIG. 1 is a perspective view of a vehicle having a crane attached thereto;

FIG. 2 is a side plan view of a hydraulic system; and

FIG. 3 is a schematic diagram of a hydraulic system.

### DETAILED DESCRIPTION OF THE PREFERRED EMBODIMENT

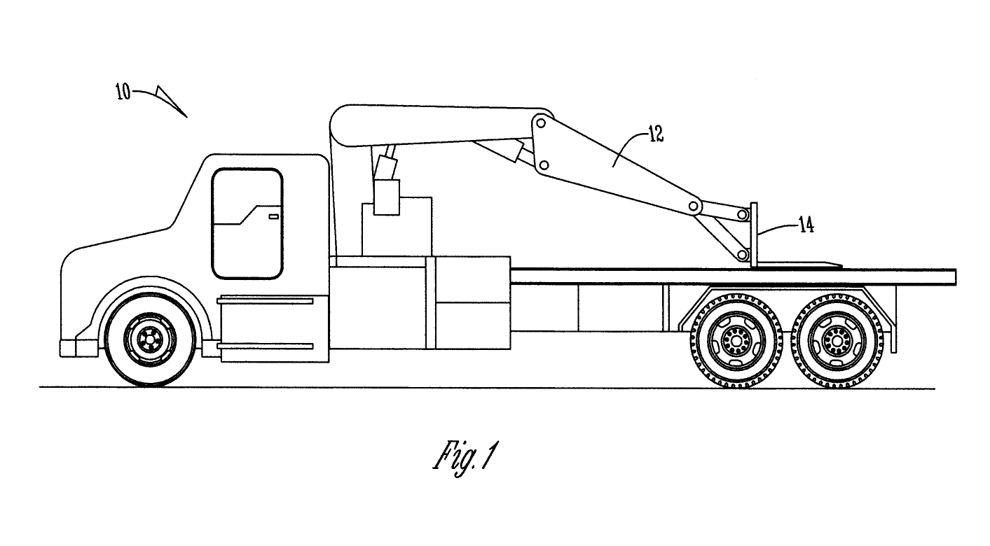

FIG. 1 shows a vehicle 10 that holds a crane 12 including rotating pads 14. The rotating pads 14 and crane 12 are typically used to lift heavy duty tires and place them at a desired location. While the vehicle 10 is shown as a commercial truck, the vehicle may be a non commercial truck, farm implement, industrial backhoe, forklift truck, or the like. The vehicle 10 and crane 12 are operated utilizing a hydraulic system (not shown) that provides fluid and pressure power to provide directional movement of the rotating pads and the like as is known in the art.

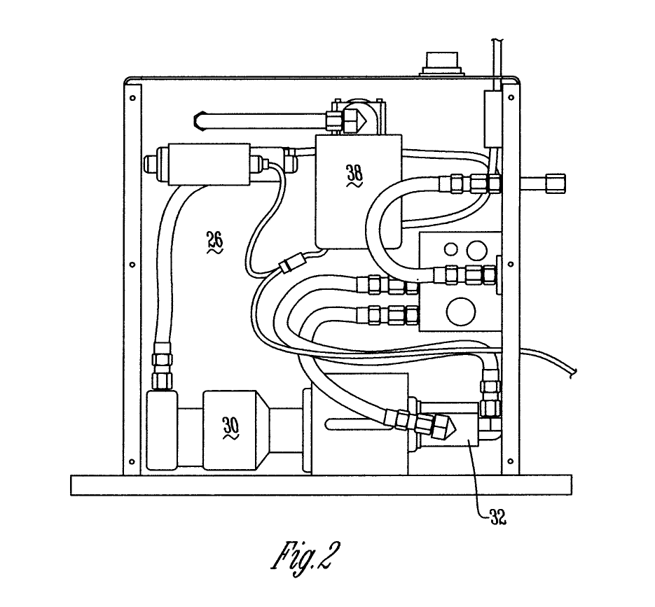

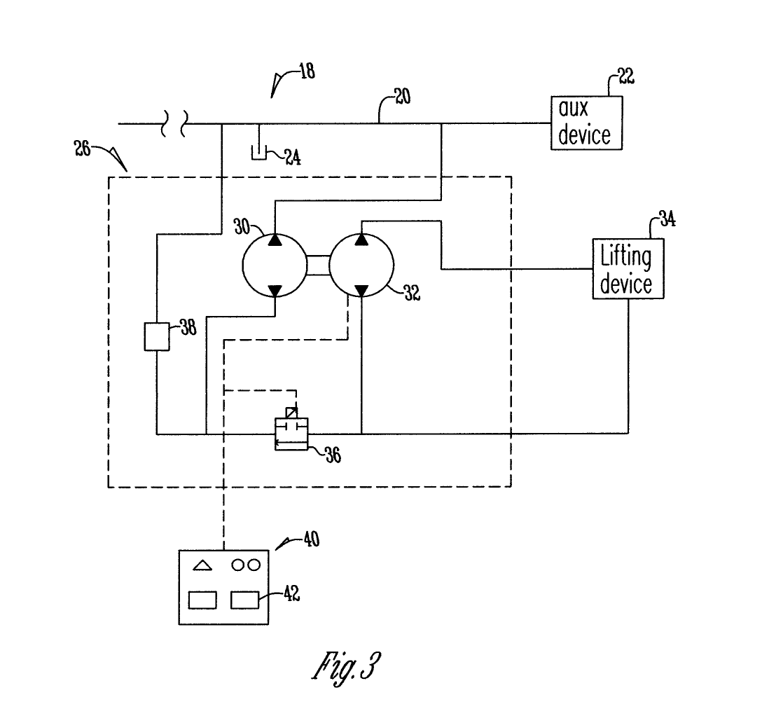

FIGS. 2 and 3 show the hydraulic crane system 18 of the present invention. Hydraulic crane system 18 includes a hydraulic line 20 of the hydraulic system of the vehicle that provides pressurized fluid to an auxiliary device 22 for operation of the crane 12 or rotating pads 14. Fluidly connected to the hydraulic line 20 is a fluid reservoir 24 to provide hydraulic fluid to both the hydraulic system of the vehicle and the hydraulic crane lift system 18. The hydraulic line 20 additionally has at least one directional valve for directing fluid flow to the desired components of the crane 12 and rotating pads 14.

The hydraulic line 20 provides fluid flow into a manifold 26 that houses a hydraulic motor 30 that drivingly operates a hydraulic pump 32. In a preferred embodiment the hydraulic pump is able to deliver 1.5 gpm at 10,000 psi as long as hydraulic flow is being delivered from the hydraulic line 20 between 7 and 40 gpm at a minimum pressure of 2500 psi. The pump 32 conveys high pressure fluid to crane lifting device 34 that operates to lift the crane 12 as desired.

Fluidly connected to the crane lifting device 34 is an electrically actuated valve 36 that in a preferred embodiment is a solenoid actuated valve. The electrically actuated valve 36 is fluidly connected to the hydraulic line 20 of the vehicle and thus provides fluid flow to the tank or hydraulic reservoir 24. Along this fluid flow path is a filter 38 for filtering fluid before going back to the hydraulic line 20 of the vehicle 10.

Electrically connected to the hydraulic pump 32 and electrically actuated valve 36 is an electronic controller 40. The electronic controller 40 has a plurality of buttons 42 that are used to operate the electronic controller 40. The controller 40 operates to send a signal to the hydraulic pump 32 in order to activate the hydraulic pump 32 so that fluid can be diverted from the hydraulic line 20 of the vehicle to the hydraulic motor 30 to operate the hydraulic pump 32 to provide high pressure fluid to the lifting device 34. The controller can also send a second signal to electrically actuated valve 36 to relieve pressurized fluid from the lifting device 34 so that the fluid flows back to the hydraulic line 20.

In operation, an individual turns on the electronic controller 40 and actuates a button 42 in order to turn on the hydraulic pump 32. By turning on the hydraulic pump 32 this starts delivering flow to the lifting device 34 from the high pressure hydraulic pump 32. During this process the vehicle functions are inoperable until the hydraulic pump 32 is shut off by releasing the button 42. After the button 42 is released, the hydraulic pump 32 is turned off and the lifting device is pressurized until an operator releases the pressure. Once the button 42 is released and the hydraulic pump 32 is no longer operating, fluid flow from reservoir 24 continues to flow through hydraulic line 20 so that the hydraulic systems of the vehicle 10 can operate as needed. Once one desires to depressurize the lifting device 34, a button 42 may be pressed on the electronic controller 40 to send a signal to the electrically actuated valve 36 in order to provide a fluid flow path from the lifting device 34 to the hydraulic line 20 to depressurize the lifting device 34.

Thus provided is an improved lift system that uses a vehicle's existing hydraulic system without effecting the vehicle's hydraulic system and performance. Specifically, the hydraulic pump 32 takes priority to the vehicle's hydraulics when activated by diverting system flow from the vehicle's hydraulics through manifold 26 in order to maintain a constant flow to hydraulic motor 30, thus driving and actuating hydraulic pump 32. As a result, the hydraulic pump 32 is a stand alone hydraulic system. Consequently, a system is provided that utilizes hydraulic fluid instead of air thus preventing freezing of the system. In addition, because hydraulic pressure and fluid is used, a smooth raising and lowering motion is provided preventing ratcheting of lifting device 34. In addition, utilization of the filter 38 ensures that the hydraulic fluid remains clean preventing potential for freezing of hydraulic fluid within the line. Also, because of the electronic controller 40 that may be operated remote from the vehicle 10, a safer system is presented. Thus, at the very least all of the stated objectives have been met.

It will be appreciated by those skilled in the art that other various modifications could be made to the device without departing from the spirit and scope of this invention.

What is claimed is:

1. A hydraulic system for lifting a crane on a vehicle comprising:
a hydraulic motor drivingly connected to a hydraulic pump and fluidly connected to a hydraulic line of the vehicle; and
a crane lifting device hydraulically actuated by fluid supplied by the hydraulic pump.

2. The hydraulic crane system of claim 1 further comprising:
an electrically actuated valve fluidly connected between the hydraulic line of the vehicle and the crane lifting device.

3. The hydraulic crane system of claim 2 further comprising:
an electronic controller electrically connected to the hydraulic pump to remotely activate the pump.

4. The hydraulic crane system of claim 3 wherein when actuated the electronic controller sends a signal to the hydraulic pump to divert fluid from the hydraulic line of the vehicle to the hydraulic motor such that pressurized hydraulic fluid is provided by the pump to the crane lifting device.

5. The hydraulic crane system of claim 2 wherein when actuated the electronic controller sends a signal to the electrically actuated valve to open a flow path between the crane lifting device and the hydraulic line of the vehicle to relieve pressure at the crane lifting device.

6. The hydraulic crane system of claim 3 wherein the electronic controller activates the pump from a location remote of the pump.
